(19) United States
(12) Patent Application Publication
(10) Pub. No.: US 2016/0109934 A1
(43) Pub. Date: Apr. 21, 2016

(54) DISPLAY DRIVER CIRCUIT INCLUDING HIGH POWER/LOW POWER INTERFACES AND DISPLAY SYSTEM

(71) Applicant: Samsung Electronics Co., Ltd., Suwon-si (KR)

(72) Inventors: SOO-YOUNG WOO, HWASEONG-SI (KR); YANG-HYO KIM, SUWON-SI (KR); SUN-YOUNG KIM, HWASEONG-SI (KR); CHUL-HO KIM, YONGIN-SI (KR); DO-KYUNG KIM, YONGIN-SI (KR); JUNG-HEE YUN, YONGIN-SI (KR)

(21) Appl. No.: 14/919,223

(22) Filed: Oct. 21, 2015

(30) Foreign Application Priority Data
Oct. 21, 2014 (KR) 10-2014-0142777

(51) Int. Cl. G06F 1/32; G09G 5/00

(52) U.S. Cl. CPC G06F 1/3293; G09G 5/006; G06F 1/3265; G09G 2310/0243; G09G 2330/021; G09G 2310/08

(57) ABSTRACT

A display driver circuit can include an input selector circuit configured to receive first display data from a high power processor circuit and configured to operate in a normal mode in which the first display data is provided and in a dormant mode in which no image data is provided to the input selector circuit and configured to receive second display data from a low power processor circuit that is configured provide the second display data when the high power processor circuit is in the dormant mode. A controller circuit, can be coupled to switch the first display data or the second display data through the input selector circuit based on the mode of operation of the high power processor circuit.

### CROSS-REFERENCE TO RELATED APPLICATION

This application claims the benefit of Korean Patent Application No. 10-2014-0142777, filed on Oct. 21, 2014, in the Korean Intellectual Property Office, the disclosure of which is incorporated herein in its entirety by reference.

### FIELD

The inventive concept relates to a semiconductor device, and more particularly, to a display driver circuit configured to drive a display panel such that an image is displayed on the display panel, and a display system including the same.

### BACKGROUND

An electronic device having an image display function, such as a computer, a tablet PC, or a smartphone, may include a display system. The display system may include a display panel, a display driver (or a display driver integrated circuit (IC) (DDI)), and a processor. The display panel may include a plurality of pixels and be embodied by a flat-panel display, such as a liquid crystal display (LCD) or an organic light emitting diode (OLED) display. The display driver may drive the display panel based on display data corresponding to an image to be displayed. Since pixels are driven in response to a data signal (display data) provided by the display driver, the image may be displayed on the display panel. The display driver may receive a control signal and the display data from a main processor of a system. The main processor may periodically transmit image data to the display driver. The main processor and the display driver may transmit or receive signals through a high-speed interface.

### SUMMARY

In some embodiments, there is provided a display system that includes a first processor circuit configured to generate first data and output the first data wherein the first processor circuit is a high-power processor circuit. A second processor circuit can be configured to generate second data and output the second data wherein the second processor circuit is a low-power processor circuit and a display driver circuit can be configured to generate a driver signal based on one of the first data received from the first processor circuit and the second data received from the second processor circuit.

The first data and the second data may be at least part of display data corresponding to an image displayed on a display panel.

The first processor may transmit the first data to the display driver circuit through a first interface, and the second processor may transmit the second data to the display driver circuit through a second interface. A transmission rate of the first interface may be higher than a transmission rate of the second interface.

The first processor may include an application processor configured to control an operation of an electronic device on which the display system is mounted, and the second processor may include a micro-control unit (MCU) configured to control a communication module or a sensor module included in the electronic device.

The second processor may generate the second data based on an external sensing signal when the first processor is in a dormant state.

The first processor may transmit a command signal indicating a lower-power operating mode to the second processor, and enter a dormant status, and the second processor may generate the second data in response to the command signal.

The second processor may generate the second data in response to the sensing signal when the external sensing signal is of a first type, and transmit the sensing signal and a normal operation request signal when the sensing signal is of a second type.

The second processor may transmit a trigger signal indicating the transmission of the second data along with the second data to the display driver circuit.

The display system may further include a third processor configured to generate third data and output the third data. The display driver circuit may generate a driver signal based on the first data received from the first processor, the second data received from the second processor, or the third data received from the third processor.

In some embodiments, there is provided a display driver circuit including an input selector that is configured to select one of first data received through a first interface and second data received through a second interface, as input data, in response to a data selection signal. An input control unit can be configured to generate the data selection signal according to an operating mode and a timing controller can be configured to perform a processing operation to display an image including the input data on a display panel.

The first data and the second data may be received from different external processors.

The input control unit may determine the operating mode based on a command signal received through the first interface.

The input control unit may determine the operating mode as a low-power operating mode when the second data is received through the second interface, and generate the data selection signal for selecting the second data.

The display driver circuit may further include a storage unit configured to store the input data. The storage unit may include a plurality of storage regions configured to sequentially store a plurality of pieces of input data that are output by the input selector in a temporal sequence.

The display driver circuit may further include an output selector configured to select one of the plurality of pieces of data output by the plurality of storage regions, as output data, in response to an output selection signal, and an output control unit configured to generate the output selection signal based on the operating mode or a time period.

The output control unit may include a clock counter configured to count applied clocks, determine the time period, and generate the output selection signal for sequentially selecting data for each time period.

According to another aspect of the inventive concept, there is provided a display driver circuit including a first interface unit configured to receive first display data from a first processor, a second interface unit configured to receive second display data from a second processor, and a timing controller configured to control an image to be displayed on a display panel based on the first display data in a first operating mode and control an image to be displayed on the display panel based on the second display data in a second operating mode.

The first interface unit and the second interface unit may transmit and receive data using a same data transmission method or different data transmission methods.

The timing controller may control an image corresponding to the first display data to be displayed on the display panel in preference to an image corresponding to the second display data.

In some embodiments, a display driver circuit can include an input selector circuit configured to receive first display data from a high power processor circuit and configured to operate in a normal mode in which the first display data is provided and in a dormant mode in which no image data is provided to the input selector circuit and configured to receive second display data from a low power processor circuit that is configured provide the second display data when the high power processor circuit is in the dormant mode. A controller circuit, can be coupled to switch the first display data or the second display data through the input selector circuit based on the mode of operation of the high power processor circuit.

### BRIEF DESCRIPTION OF THE DRAWINGS

FIG. 1 is a block diagram of a display system according to an exemplary embodiment of the inventive concept;

FIG. 2 is a timing diagram of the display system shown in FIG. 1;

FIG. 3 is a block diagram of a display driver circuit according to an exemplary embodiment of the inventive concept;

FIG. 4 is a block diagram of a system control unit according to an exemplary embodiment of the inventive concept;

FIG. 5 is a diagram of an example of symbol image data stored in a look-up table;

FIG. 6 is a flowchart of a method of operating a display system, according to an exemplary embodiment of the inventive concept;

FIG. 7 is a flowchart of a method of operating a display system, according to an exemplary embodiment of the inventive concept;

FIG. 8 is a block diagram of a display driver circuit according to an exemplary embodiment of the inventive concept;

FIG. 9 is a timing diagram illustrating operations of a display system including the display driver circuit of FIG. 8;

FIG. 10 is a block diagram of a system control unit according to an exemplary embodiment of the inventive concept;

FIG. 11A is a diagram of second display data generated by a second processor shown in FIG. 10;

FIG. 11B is a diagram showing a variation in an image displayed on a display panel;

FIG. 12 is a block diagram of a system control unit according to an exemplary embodiment of the inventive concept;

FIG. 13 is a diagram showing a variation in an image displayed on a display panel according to an operation of the second processor shown in FIG. 12;

FIG. 14 is a block diagram of a display system according to an exemplary embodiment of the inventive concept;

FIG. 15 is a block diagram of a display device according to an exemplary embodiment of the inventive concept;

FIG. 16 is a diagram of a display module according to an exemplary embodiment of the inventive concept;

FIG. 17 is a block diagram of an electronic device according to an exemplary embodiment of the inventive concept; and

FIG. 18 is a diagram of various applied examples of an electronic product to which a display device according to an exemplary embodiment of the inventive concept is mounted.

### DETAILED DESCRIPTION OF THE EMBODIMENTS

The present inventive concept will now be described more fully hereinafter with reference to the accompanying drawings, in which exemplary embodiments of the inventive concept are shown. These embodiments are provided so that this disclosure is thorough and complete and fully conveys the scope of the inventive concept to one skilled in the art. Accordingly, while the inventive concept can be modified in various ways and take on various alternative forms, specific embodiments thereof are shown in the drawings and described in detail below as examples. There is no intent to limit the inventive concept to the particular forms disclosed. On the contrary, the inventive concept is to cover all modifications, equivalents, and alternatives falling within the spirit and scope of the appended claims. Like reference numerals refer to like elements throughout.

It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

As used herein, the term “or” includes any and all combinations of one or more of the associated listed items. For example, the expression “A or B” may include A, B, or both A and B. Expressions such as “at least one of,” when preceding a list of elements, modify the entire list of elements and do not modify the individual elements of the list.

It will be understood that, although the terms first, second, etc. may be used herein to describe various elements, components, regions, layers and/or sections, these elements, components, regions, layers and/or sections should not be limited by these terms. Thus, a first element, component, region, layer or section discussed below could be termed a second element, component, region, layer or section without departing from the teachings of the inventive concept.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements.

The terminology used herein is for the purpose of describing particular embodiments only and is not intended to be limiting of example embodiments. As used herein, the singular forms “a”, “an”, and “the” are intended to include the plural forms as well, unless the context clearly indicates otherwise.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A display system according to various exemplary embodiments of the inventive concept may be an electronic device having an image display function. For example, the electronic device may include at least one of a smartphone, a tablet PC, a mobile phone, a video phone, an e-book reader, a desktop PC, a laptop PC, a netbook computer, a personal digital assistant (PDA), a portable multimedia player (PMP), an MPEG-1 audio layer III (MP3) player, a mobile medical device, a camera, or a wearable device, such as a head-mounted device (HMD) (e.g., electronic glasses), electronic clothes, an electronic bracelet, an electronic necklace, an electronic accessory, electronic tattoos, or a smart watch.

In some embodiments, the display system may be a smart home appliance having an image display function. The smart home appliance may include, for example, at least one of a TV, a DVD player, an audio player, a refrigerator, an air conditioner, a vacuum cleaner, an oven, a microwave oven, a washing machine, an air freshener, a set-top box, a TV box (e.g., Samsung HomeSync™, Apple TV™, or Google TV™), game consoles, an electronic dictionary, an electronic key, a camcorder, or an electronic frame.

In some exemplary embodiments, the display system may include at least one of various medical devices (e.g., magnetic resonance angiography (MRA), magnetic resonance imaging (MRI), computed tomography (CT), an imaging device, or an ultrasonic device), a navigation device, a global positioning system (GPS) receiver, an event data recorder (EDR), a flight data recorder (FDR), an in-vehicle infotainment device, marine electronic equipment (e.g., a marine navigation device and a gyrocompass), an aerial electronic device (avionics), a security device, a car head unit, an industrial or household robot, an automatic teller machine (ATM) of a financial institution or a point of sales (POS) of a store.

In some embodiments, the display system may include at least one of furniture or a portion of a building/structure, which has an image display function, an electronic board, an electronic signature receiving device, a projector, or various measuring devices (e.g., tap water, electricity, gas, and radio-wave measuring devices). An electronic device including the display system according to the various exemplary embodiments of the inventive concept may be one or a combination of the above-described various apparatuses. Also, the display system may be a flexible apparatus. It will be understood that the display system according to various exemplary embodiments of the inventive concept is not limited to the above-described apparatuses.

Hereinafter, display systems according to various exemplary embodiments of the inventive concept will be described with reference to the appended drawings. In the various exemplary embodiments, the term “user” may refer to a user of a display system or a device (e.g., an artificial intelligence (AI) electronic device) using the display system.

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions

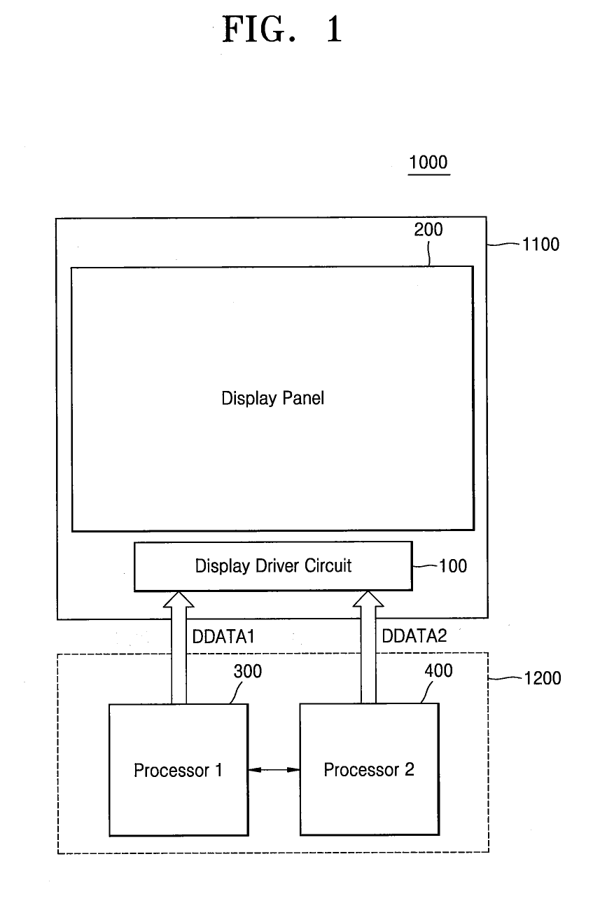

FIG. 1 is a block diagram of a display system 1000 according to an exemplary embodiment of the inventive concept.

Referring to FIG. 1, the display system 1000 may include a display device 1100 and a system control unit 1200.

The display device 1100 may include a display driver circuit 100 and a display panel 200, and display images under the control of the system control unit 1200. In an exemplary embodiment, the display device 1100 may be embodied by a single module.

The display panel 200 may include a plurality of pixels arranged in a matrix form and display images in frame units. The display panel 200 may be embodied by one of a liquid crystal display (LCD), a light emitting diode (LED) display, an organic LED (OLED) display, an active-matrix OLED (AMOLED) display, an electrochromic display (ECD), a digital mirror device (DMD), an actuated mirror device (AMD), a grating light value (GLV), a plasma display panel (PDP), an electro-luminescent display (ELD), and a vacuum fluorescent display (VFD), or embodied by one of other kinds of flat-panel displays (FPDs) or flexible displays.

The display driver circuit 100 may generate a driver signal to display an image corresponding to display data on the display panel 200, based on display data DDATA1 and DDATA2 and the control signal applied from the system control unit 1200.

The system control unit 1200 may provide the display data DDATA1 and DDATA2 and the control signal to the display driver circuit 100 and generally control a display operation of the display device 1100. The display data DDATA1 and DDATA2 may be part or all of data of one frame corresponding to an image to be displayed on the display panel 200.

In addition, in the display system 1000 according to an exemplary embodiment of the inventive concept, the system control unit 1200 may include a plurality of processors, for example, first and second processors 300 and 400, which may generate the display data DDATA1 and DDATA2 and provide the display data DDATA1 and DDATA2 to the display driver circuit 100, respectively. As shown in FIG. 1, the system control unit 1200 may include the first processor 300 and the second processor 400, wherein the first processor 300 may generate first display data DDATA1, and the second processor 400 may generate second display data DDATA2. In some exemplary embodiments, the first processor 300, the second processor 400, and the display driver circuit 100 may be embodied by discrete chips or embodied by one module, one System-on-Chip (SoC), or one package (e.g., one multi-chip package (MCP)).

For brevity, FIG. 1 illustrates an example in which the system control unit 1200 includes two processors, namely, the first and second processors 300 and 400. However, the inventive concept is not limited thereto, and the system control unit 1200 may include at least three processors.

The display driver circuit 100 may display an image on the display panel 200, based on one of the received first display data DDATA1 and second display data DDATA2.

In an exemplary embodiment, the first processor 300 and the display driver circuit 100 may transmit or receive the first display data DDATA1 through a first interface, and the second processor 400 and the display driver circuit 100 may transmit or receive the second display data DDATA2 through a second interface.

The first interface and the second interface may be of the same type or different types. The first interface or the second interface may include, for example, one of an RGB interface, a CPU interface, a serial interface, a mobile display digital interface (MDDI), an inter integrated circuit (12C) interface, a serial peripheral interface (SPI), a micro-controller unit (MCU) interface, a mobile industry processor interface (MIPI), an embedded displayport (eDP) interface, or a high-definition multimedia interface (HDMI).

In an exemplary embodiment, a transmission rate of the first interface may be higher than a transmission rate of the second interface.

In an exemplary embodiment, the first processor 300 may be a main processor, and the second processor 400 may be a sub-processor. When the display system 1000 is in a first operating mode, for example, a normal operating mode, the display data and the control signal may be provided by the first processor 300. The display driver circuit 100 may display an image based on the first display data DDATA1 received from the first processor 300. When the display system 1000 is in a second operating mode, for example, a low-power operating mode, the first processor 300 may maintain a dormant status, and the display data and the control signal may be provided by the second processor 300. The display driver circuit 100 may display an image based on the second display data DDATA2 received from the second processor 400. As an example, the display system 1000 may operate in a normal operating mode when an image displayed on the display panel 200 is a moving image or when the image varies rapidly, and operate in a low-power mode when there is no variation in the image displayed on the display panel 200 or when a typically predictable image is displayed on the display panel 200.

In an exemplary embodiment, the first processor 300 may be a main processor (e.g., an application processor (AP)) of an electronic device on which the display system 1000 according to the present embodiment is mounted. The second processor 400 may be an MCU included in a specific module (e.g., a communication module or sensor module) of the electronic device. Thus, the first processor 300 may operate at higher speed than the second processor 400. Also, the first processor 300, when active, may consume more power than the second processor 400.

A display system may display an image based on display data received from a processor of the system control unit. Power consumption of the processor may take up a large portion of the whole power consumption of the display system. However, the processor may operate to provide display data not only in the case of rapidly varying images (e.g., moving images) but also in the case of slowly varying images or typically predictable images, so that the whole power consumption of the display system may increase. The display system 1000 according to an exemplary embodiment of the inventive concept may include the first processor 300 and the second processor 400. When the display system 1000 is in a normal operating mode, the first processor 300 that operates at a relatively high speed may generate display data and provide the display data to the display driver circuit 100. When the display system 1000 is in a low-power operating mode, the second processor 400 that consumes relatively low power may generate display data and provide the display data to the display driver circuit 100. Since the first processor 300 may maintain a dormant status in the low-power operating mode, power consumption of the display system 1000 may be reduced. Also, when the display system 1000 is in the low-power operating mode, the first processor 300 may perform operations related with other modules of an electronic device on which the display system 1000 is mounted, thereby reducing the burden of display operations of the first processor 300.

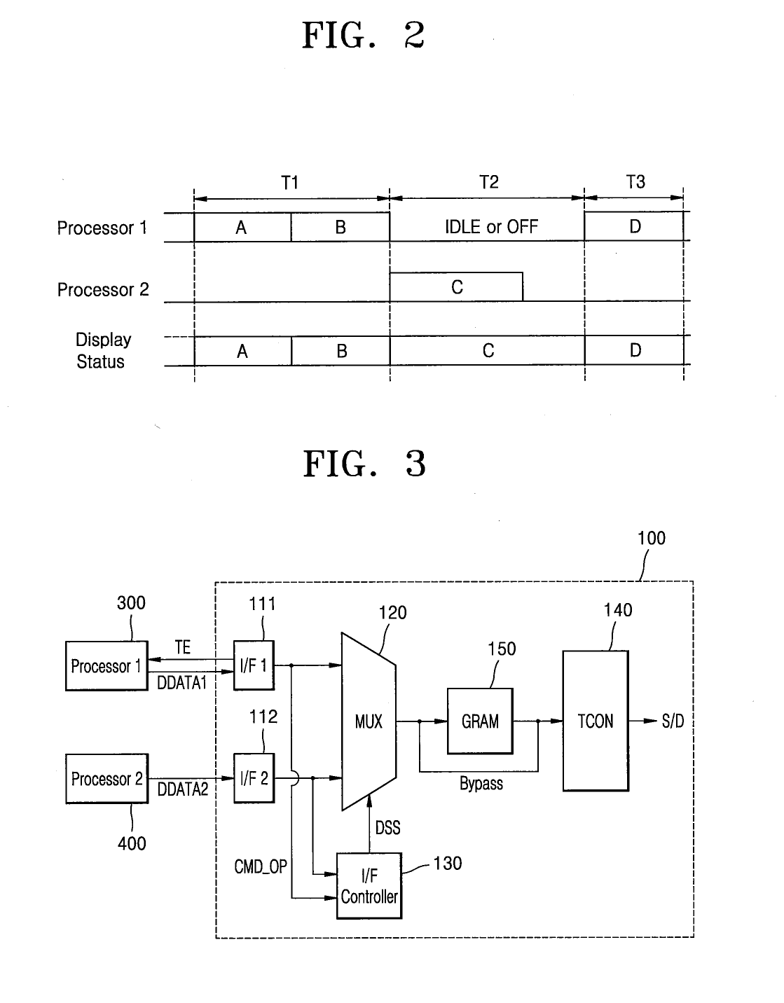

FIG. 2 is a timing diagram of the display system 1000 of FIG. 1.

Referring to FIGS. 1 and 2, the display system 1000 may operate in a normal operating mode for a first time period T1. The first processor 300 may generate first display data DDATA1 and provide the first display data DDATA1 to the display driver circuit 100. First display data DDATA1 corresponding to a first image A and a second image B may be sequentially provided to the display driver circuit 100, and the first image A and the second image B may be sequentially displayed on the display panel 200.

Thereafter, the display system 1000 may operate in a low-power operating mode for a second time period T2. The first processor 300 may be maintained in a dormant status (e.g., an idle status or an off status), and the second processor 400 may generate second display data DDATA2 and provide the second display data DDATA2 to the display driver circuit 100. The second processor 400 may provide second display data DDATA2 corresponding to a third image C to the display driver circuit 100, and the third image C may be displayed on the display panel 200 for the second time period T2 based on the second display data DDATA2.

The display system 1000 may operate in the normal operating mode again for a third time period T3. The first processor 300 may generate first display data DDATA1 corresponding to a fourth image D and provide the first display data DDATA1 to the display driver circuit 100, and the fourth image D may be displayed on the display panel 200.

When a variation in the image displayed on the display panel 200 is not rapid as in the second time period T2, the second processor 300 may operate instead of the first processor 300, generate display data, and provide the display data to the display driver circuit 100. Thus, the first processor 300 may be maintained in the dormant status.

FIG. 2 illustrates a case in which a time period for which first display data DDATA1 corresponding to the first, second, and fourth images A, B, and D is transmitted does not overlap a time period for which second display data DDATA2 corresponding to the third image C is transmitted, but the inventive concept is not limited thereto. The time period for which the first display data DDATA1 is transmitted may at least partially overlap the time period for which the second display data DDATA2 is transmitted.

FIG. 3 is a block diagram of a display driver circuit 100 according to an exemplary embodiment of the inventive concept.

Referring to FIG. 3, the display driver circuit 100 may include first and second interface units 111 and 112, a first MUX 120, a first controller 130, and a timing controller 140. The display driver circuit 100 may further include a memory 150.

The first interface unit 111 may receive first display data DDATA1 and a control signal (for example, a command signal and clock signal) from the first processor 300. The first interface unit 111 and the first processor 300 may transmit or receive data in a first interface manner. In an exemplary embodiment, the first interface unit 111 may transmit a tearing effect control signal TE indicating that it is possible to receive display data, to the first processor 300, and the first processor 300 may transmit the first display data DDATA1 in response to the signal.

The second interface unit 112 may receive second display data DDAT2 and a control signal from the second processor 300. The second interface unit 112 and the second processor 400 may transmit or receive data in a second interface manner. The second interface manner may be the same as or different from the first interface manner. In an exemplary embodiment, a transmission rate of the first interface manner may be higher than a transmission rate of the second interface manner.

In an exemplary embodiment, the second processor 400 may transmit a trigger signal indicating that transmitted data is display data, along with the second display data DDATA2, and the second interface unit 112 may determine that data received from the second processor 400 is the second display data DDAT2, based on the trigger signal TR.

The first interface unit 111 and the second interface unit 112 may convert the received first and second display data DDATA1 and DDATA2 into a format, which may be used in the display driver circuit 100, and provide the first and second display data DDATA1 and DDATA2 to the first MUX 120.

The first MUX 120 may select one of the first display data DDATA1 and the second display data DDATA2 based on a data selection signal DSS. The first MUX 120 may be an input selector configured to select input display data. The first MUX 120 may provide display data selected out of the first display data DDATA1 and the second display data DDATA2, to the timing controller 140.

The first controller 130 may generate a data selection signal DSS according to an operating mode. For example, the first controller 130 may be an interface control device configured to select the first and second interface units 111 and 112 configured to receive display data according to the operating mode.

In an exemplary embodiment, the first controller 130 may determine an operating mode based on a first command CMD_OP received from the first processor 300 and generate a data selection signal DSS based on the determination result. The first command CMD_OP may be a command configured to control an operating mode of the display driver circuit 100. The first controller 130 may determine operating modes of the display driver circuit 100 and the display system (refer to 1000 in FIG. 1) including the display driver circuit 100 in response to the first command CMD_OP. In an exemplary embodiment, the first controller 130 may determine the operating mode as a first operating mode or a second operating mode. For example, the first operating mode may be a normal operating mode, and the second operating mode may be a low-power operating mode.

In an exemplary embodiment, the first controller 130 may analyze the received display data DDATA1 and DDATA2 and determine an operating mode. For example, when the first display data DDATA1 is received, the first controller 130 may determine the operating mode as a first operating mode and generate a data selection signal DSS at a first level, for example, a high level. The first MUX 120 may select the first display data DDATA1 as input display data based on the high-level data selection signal DSS.

Thereafter, when the second display data DDATA2 is received from the second processor 400, the first controller 130 may determine the operating mode as a second operating mode and generate a data selection signal DSS at a second level, for example, a low level. The first MUX 120 may select the second display data DDATA2 as input display data based on the low-level data selection signal DSS.

Meanwhile, when the first display data DDATA1 and the second display data DDATA2 are simultaneously received, the first controller 130 may generate a data selection signal DSS at a level set as a default. For example, the first controller 130 may prioritize the first display data DDATA1 over the second display data DDATA2, and generate a first-level (e.g., high-level) second selection signal. Thus, an image corresponding to the first display data DDATA1 may be displayed on the display panel (refer to 200 in FIG. 1) in preference to an image corresponding to the second display data DDATA2.

The timing controller 140 may perform a processing operation for displaying an image on the display panel 200, based on the display data provided by the first MUX 120. For example, the timing controller 140 may output applied display data to the source driver S/D in line units or protocol-convert the applied display data to meet specifications for an interface with the source driver S/D and output the converted display data to the source driver S/D. Also, the timing controller 140 may generate a control signal for determining a time point in which a source driver S/D or a gate driver will operate, and provide the control signal to the source driver S/D or the gate driver.

In an exemplary embodiment, the display data output by the first MUX 120 may be directly applied to the timing controller 140 or temporarily stored in the memory 150 and then output to the timing controller 140.

The memory 150 may be graphic random access memory (graphic RAM) configured to store display data in frame units or a line buffer configured to store display data in line units. The memory 150 may include a volatile memory device, such as dynamic RAM (DRAM) and static RAM (SRAM), and/or a non-volatile memory device, such as a flash memory. The memory 150 may include DRAM, phase-change RAM (PRAM), magnetic RAM (MRAM), resistive RAM (ReRAM), ferromagnetic RAM (FRAM), a NOR flash memory, a NAND flash memory, or a fusion flash memory (e.g., a memory in which an SRAM buffer, a NAND flash memory, and a NOR interface logic are combined).

In an exemplary embodiment, when the display driver circuit 100 is in the first operating mode, display data output by the first MUX 120 may be directly applied to the timing controller 140. When the display driver circuit 100 is in the second operating mode, display data output by a first MUX 120 may be temporarily stored in the memory 150 and then output to the timing controller 140. An image corresponding to the display data stored in the memory 150 may be displayed on the display panel 200 during a time of a plurality of frames.

The display driver circuit 100 may further include an image processing block. Display data output by the first MUX 120 or display data output by the memory 150 may be provided to the image processing block, and the image processing block may perform an image processing operation on the display data to improve resolution or display of the data. The image-processed display data may be provided to the timing controller 140.

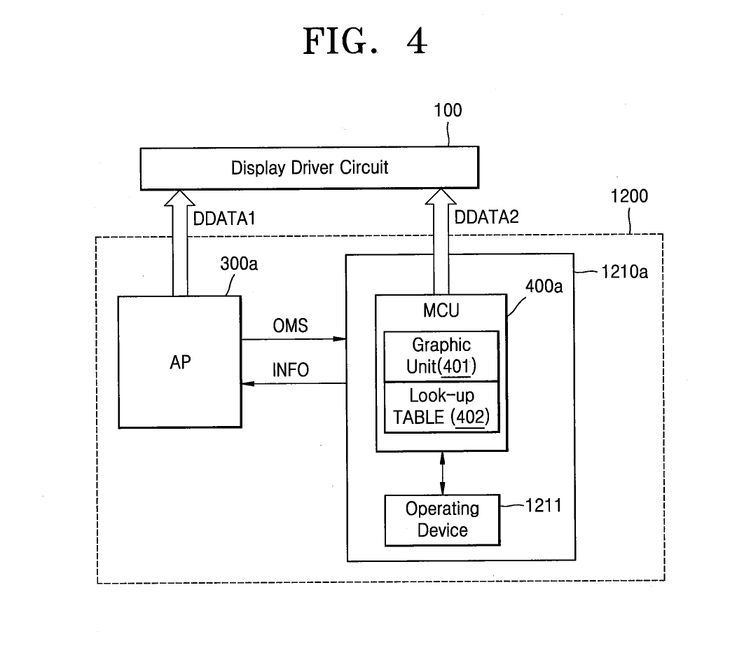

FIG. 4 is a block diagram of a system control unit 1200 according to an exemplary embodiment of the inventive concept.

Referring to FIG. 4, the system control unit 1200 may include a first processor 300a and a first operating module 1210a that may include a second processor 400a.

The first processor 300a may generate first display data DDATA1 and provide the first display data DDATA1 to the display driver circuit 100. In an exemplary embodiment, the first processor 300a may be a main processor of an electronic device including the system control unit 1200. The first processor 300a may control an overall operation of the electronic device and discrete operations of operating modules included in the electronic device. For example, the first processor 300a may be an application processor (AP). Hereinafter, the first processor 300a will be referred to as an AP.

The first operating module 1210a may be an operating module configured to perform a specific operation in the electronic device including the system control unit 1200. For example, the first operating module 1210a may be a communication module, a sensor module, an input/output (I/O) module, or a power management module.

The first operating module 1210a may include a second processor 400a and an operating device 1211. The second processor 400a may be a micro control unit (MCU). Hereinafter, the second processor 400a will be referred to as an MCU. The operating device 1211 is configured to perform the operation of the first operating module 1210a. The operating device 1211 may externally transmit or receive data or sense a status of an internal or external environment of the system control unit 1200 in connection with the operation of the first operating module 1210a. For example, the operating device 1121 may be an RF device, one of various sensors, or an I/O device, such as a touch panel or a keyboard.

The MCU 400a may control an operation of the first operating module 1210a and provide a control signal to the operating device 1211 or receive a sensing signal from the operating device 1211. For instance, when the first operating module 1210a is a communication module, the MCU 400a may receive a signal transmitted to the RF device or information regarding the signal from the RF device. Also, when the first operating module 1210a is a sensor module, the MCU 400a may receive a sensing signal received by one of the various sensors or information regarding the sensing signal.

The MCU 400a may provide sensing information INFO regarding the received signal or the sensing signal to the AP 300a, and the AP 300a may generate first display data DDATA1 for updating the image displayed on the display panel (refer to 200 in FIG. 1) based on the sensing information INFO.

In the system control unit 1200 according to the present embodiment, the AP 300a may determine an operating mode and provide an operating mode signal OMS (or an operating-mode conversion signal) indicating the operating mode to the MCU 400a. When the operating mode signal OMS indicates a second operating mode, for example, a low-power operating mode, the MCU 400a may generate second display data DDATA2 based on the sensing information INFO, and directly provide the second display data DDATA2 to the display driver circuit 100. In this case, the AP 300a may transmit an operating mode signal OMS indicating a second operating mode to the MCU 400a and enter a dormant status.

In an exemplary embodiment, the MCU 400a may include a graphics unit 401 or a look-up table 402 to generate the second display data DDATA2.

The graphics unit 401 may generate the second display data DDATA2 based on the sensing information INFO and a reference image. The graphics unit 401 may be embodied by hardware, software, firmware, an IC or a combination thereof.

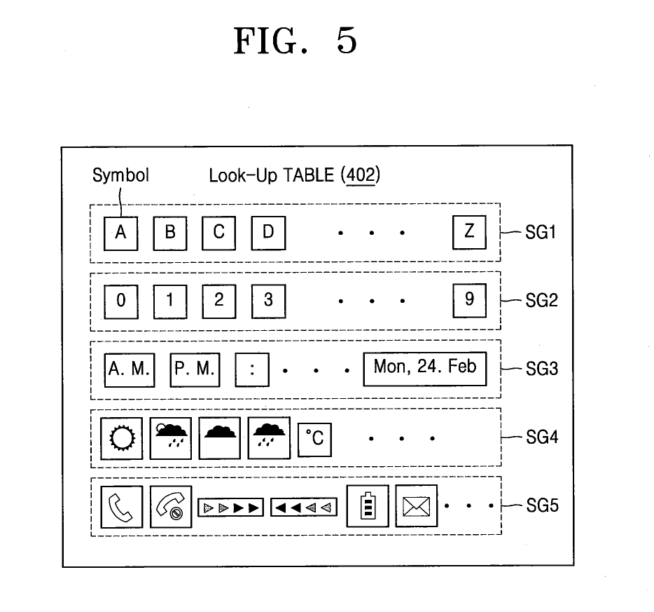

The look-up table 402 may previously store the reference image, for example, symbol image data, and provide the reference image to the graphics unit 401. Various symbol image data may be stored in the look-up table 402, as shown in FIG. 5.

FIG. 5 is a diagram of an example of symbol image data stored in the look-up table 402. Referring to FIG. 5, the look-up table 402 may include letter symbols SG1, number symbols SG2, symbols SG3 indicating times or dates, and symbols SG4 indicating the weather or temperatures. In addition, the look-up table 402 may include various symbols according to the type of an electronic product on which the display system (refer to 1000 in FIG. 1) is mounted. For example, when the display system 1000 includes a smartphone or a smartwatch, the look-up table 402 may include symbols SG5 indicating the answering of a phone call, a message, and a battery level.

Referring back to FIG. 4, in an exemplary embodiment, the MCU 400a may determine a type of sensing information INFO and determine whether the MCU 400a is to directly generate second display data DDATA2 or make a wake-up request of the AP 300a, based on the determination result. For example, sensing information INFO of a first type may include a variation in temperature, humidity, weather, time, date, or human heart rate or the receiving of text data, and sensing information INFO of a second type may include the receiving of a moving image and the receiving of a complicated image. The type of the sensing information INFO may be previously set in consideration of the complexity of generation of display data. When the sensing information INFO is of the first type, since a simple variation of an image displayed on the display panel 200 or a variation of part of the image is required, the MCU 400a itself may generate the second display data DDATA2.

However, when the sensing information INFO is of the second type, since an image displayed on the display panel 200 should be changed complicatedly or rapidly, it may be difficult for the MCU 400a to generate second display data DDATA2 corresponding to the sensing information INFO. Accordingly, the MCU 400a may make a wake-up request of the AP 300a. The MCU 400a transmits a signal for requesting a normal operation and the sensing information INFO to the AP 300a. The AP 300a may exit from the dormant status in response to the request from the MCU 400a and generate first display data DDATA1 based on the sensing information INFO.

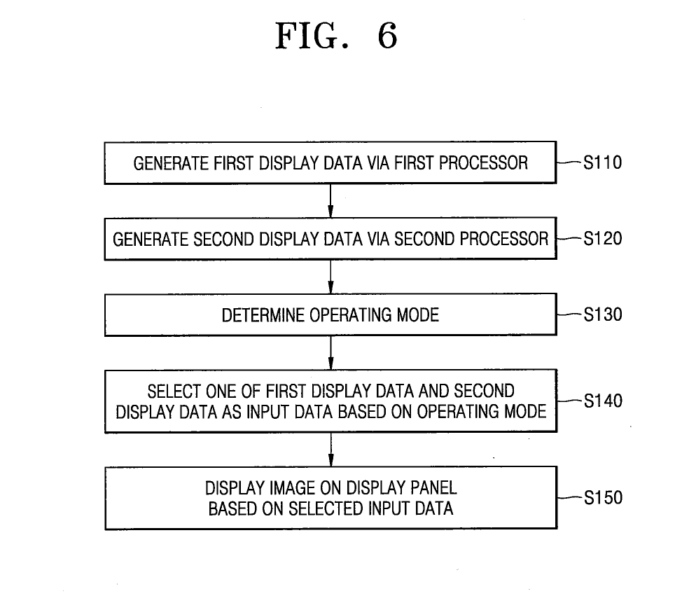

FIG. 6 is a flowchart of a method of operating a display system, according to an exemplary embodiment of the inventive concept. The method of operating the display system, according to the present embodiment, may be applied to the display system 1000 of FIG. 1.

Referring to FIG. 6, a first processor may generate first display data (S110), and a second processor may generate second display data (S120). The operation S110 of generating the first display data and the operation S120 of generating the second display data may be performed at the same time or at different times.

A display driver circuit may determine an operating mode (S130). In an exemplary embodiment, the display driver circuit may determine an operating mode in response to a command signal that is received from the first processor and indicates the operating mode. In another exemplary embodiment, the display driver circuit may analyze the received first display data or second display data and determine the operating mode. As an example, when the display driver circuit starts receiving the first display data, the display driver circuit may determine the operating mode as a first operating mode, for example, a normal operating mode. When the display driver circuit starts receiving the second display data, the display driver circuit may determine the operating mode as a second operating mode, for example, a low-power operating mode. As another example, the display driver circuit may determine the operating mode depending on the nature of the data such as, whether the received first display data or second display data is a moving image or a still image, or corresponds to an image into which only part of an image presently displayed on a display panel is changed.

The display driver circuit may select one of the first display data and the second display data as input data based on the operating mode (S140). The display driver circuit may select the first display data when the operating mode is the first operating mode, for example, the normal operating mode, and select the second display data when the operating mode is the second operating mode, for example, the low-power operating mode.

An image may be displayed on the display panel based on the selected input data (S150). When the operating mode is the first operating mode, an image corresponding to the first display data received from the first processor may be displayed on the display panel. When the operating mode is the second operating mode, an image corresponding to the second display data received from the second processor may be displayed on the display panel.

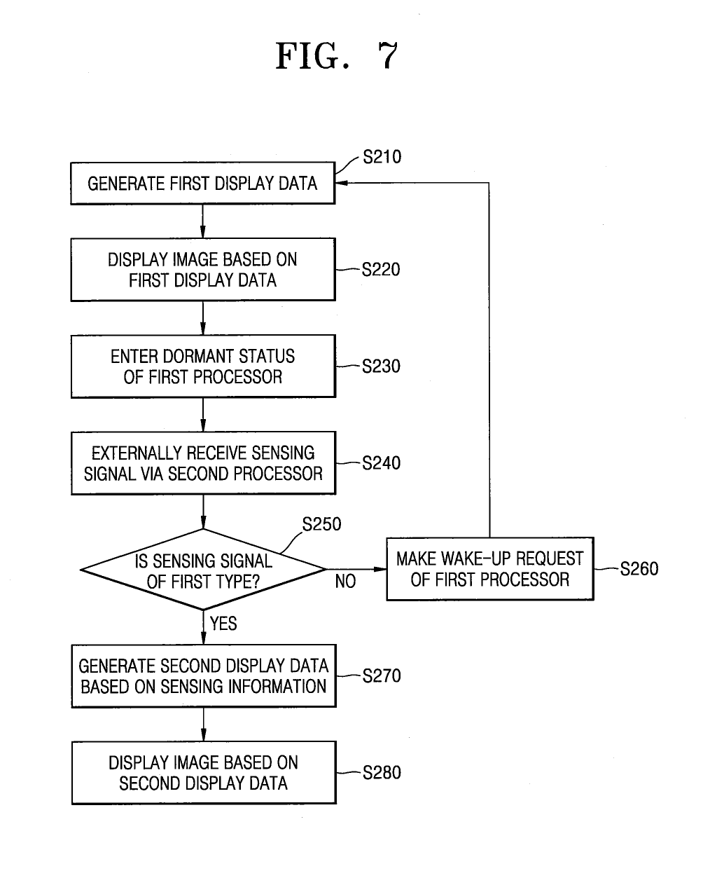

FIG. 7 is a flowchart of a method of operating a display system, according to another exemplary embodiment of the inventive concept. The method of operating the display system, according to the present embodiment, may be particularly related to an operation conversion sequence between a first processor and a second processor and applied to the display system 1000 of FIG. 1 and the system control unit 1200 of FIG. 4.

Referring to FIG. 7, initially, the display system may operate in a first operating mode, for example, a normal operating mode. A first processor may generate first display data (S210), and a display driver circuit may display an image on a display panel based on first display data (S220).

Thereafter, the display system may operate in a second operating mode, and the first processor may enter a dormant status (S230). The first processor may transmit a signal indicating the second operating mode or a signal indicating conversion of an operating mode to another processor, for example, a second processor. Thus, generation of display data may be performed by the second processor instead of the first processor. In this case, when it is necessary to vary an image displayed on the display panel according to a sensing signal, the second processor may generate second display data.

The second processor may externally receive a sensing signal (S240). As described above with reference to FIG. 4, the second processor may be an MCU included in an operating module, such as a communication module or a sensor module. An operating device, such as an RF device or a sensor, may externally receive data or sense an external environment and provide a sensing signal to the second processor.

The second processor may determine a type of the sensing signal or a type of sensing information in response to the sensing signal (S250). For example, the second processor may determine whether the sensing signal or the sensing information is of a first type or a second type. The first type may include a variation in temperature, humidity, weather, time, date, or human heart rate or the receiving of text data, and the second type may include the receiving of a moving image or the receiving of a complicated image.

If the sensing signal or the sensing information is not of the first type, for example, when the sensing information is of the second type, the second processor may make a wake-up request of the first processor (S260). The first processor may exit from the dormant status and perform a normal operation in response to the wake-up request. The first processor may generate first display data based on the sensing signal or the sensing information (S210).

Otherwise, if the sensing signal or the sensing information is of the first type, the second processor may generate second display data (S270), and the display driver circuit may display an image on the display panel based on the second display data (S280).

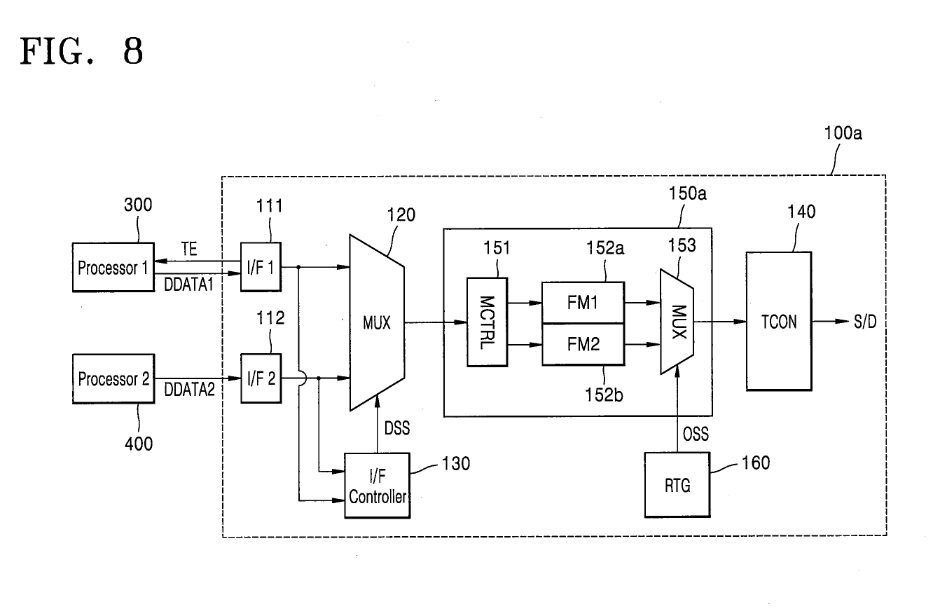

FIG. 8 is a block diagram of a display driver circuit 100a according to an exemplary embodiment of the inventive concept.

Referring to FIG. 8, the display driver circuit 100a may include a first interface unit 111, a second interface unit 112, a first MUX 120, a first controller 130, a timing controller 140, a memory module 150a, and a second controller 160.

The memory module 150a may include a memory controller 151, a plurality of memory regions, for example, first and second memory regions 152a and 152b, and a second MUX 153. The memory module 150a may store input display data output by the first MUX 120, in the plurality of memory regions (for example, first and second memory regions 152a and 152b), and sequentially output the stored display data.

The memory controller 151 may control write and read operations on the first and second memory regions 152a and 152b. The memory controller 151 may control the input display data output by the first MUX 120 to be sequentially written in the first and second memory regions 152a and 152b, and control display data stored in the first and second memory regions 152a and 152b to be read in the written order. In an exemplary embodiment, the memory controller 151 may control a write operation or a read operation to simultaneously be performed on the first and second memory regions 152a and 152b.

Each of the first and second memory regions 152a and 152b may be a frame memory configured to store display data in frame units. FIG. 8 illustrates a case in which both the first memory region 152a and the second memory region 152b are included in the memory module 150a for brevity, but the inventive concept is not limited thereto. The memory module 150a may include at least two memory regions.

The second MUX 153 may select one of a plurality of pieces of display data output by the first and second memory regions 152a and 152b as output display data in response to an output selection signal OSS, and provide the selected display data to the timing controller 140.

The second controller 160 may generate the output selection signal OSS based on an operating mode or a time period. In an exemplary embodiment, the second controller 160 may include a clock counter (or a real-time generator) configured to count applied clocks and generate time information. The second controller 160 may determine a predetermined time period based on the generated time information and sequentially select display data at intervals of a predetermined time period.

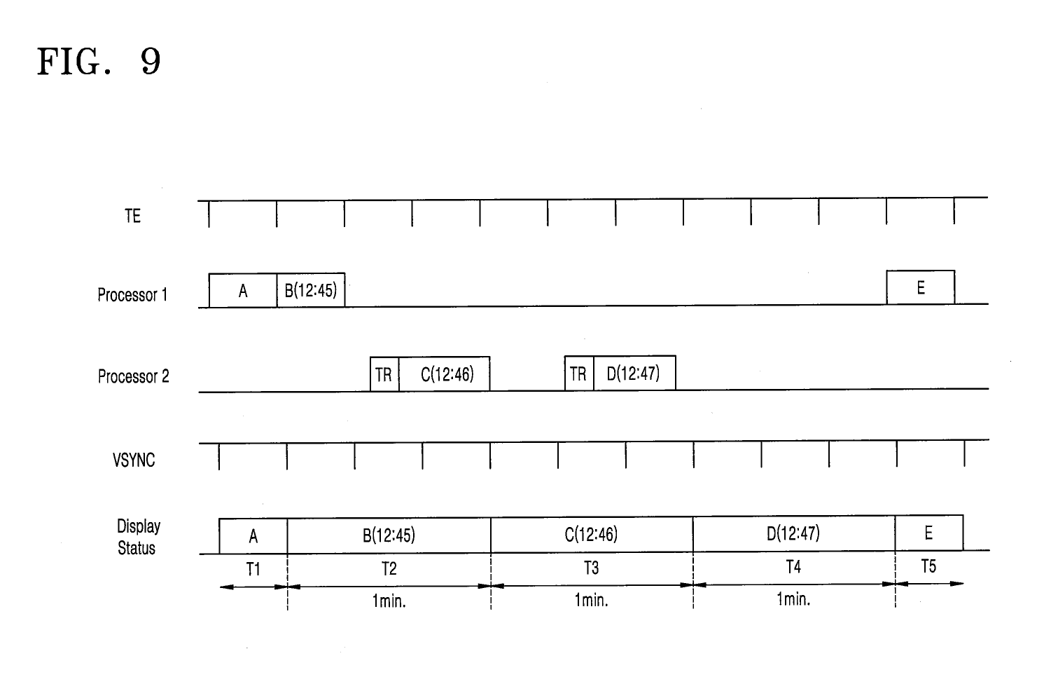

Hereinafter, operations of the display driver circuit 100a of FIG. 8 will be described in further detail with reference to FIG. 9.

FIG. 9 is a timing diagram illustrating operations of a display system including the display driver circuit 100a of FIG. 8. FIG. 9 illustrates a case in which a display system according to an exemplary embodiment of the inventive concept operates as a clock application.

Referring to FIG. 9, the display system may operate in a first operating mode, for example, a normal operating mode, a first processor 300 may sequentially provide first display data DDATA1 corresponding to a first image A and a second image B to the display driver circuit 100a. In an exemplary embodiment, as shown in FIG. 9, the display driver circuit 100a may transmit a mark signal indicating a status in which display data may be received, for example, a tearing effect control (TE) signal, to the first processor 300, and the first processor 300 may sequentially transmit the first display data DDATA1 to the display driver circuit 100a in response to the TE signal. The display driver circuit 100a may display an image on the display panel (refer to 200 in FIG. 1) in response to a vertical synchronous signal VSYNC. The first image A may be displayed for a first time period T1, and a second image B may be displayed for a second time period T2. Meanwhile, the second image B may be an image that indicates a time of twelve forty-five (12:45). Thus, the time image may be displayed on the display panel 200 after the first time period T1. Since the time image is simple and updated at intervals of a predetermined time amount, for example, at intervals of 1 minute, the time image may not vary rapidly and may only partially change. Therefore, the display system may operate in a second operating mode, for example, a low-power mode. The first processor 300 may enter a dormant status, and the second processor 400 may update the time image. The second processor 400 may generate second display data DDATA2 corresponding to time images that are updated at intervals of one minute, for example, a third image C indicating twelve forty-six (12:46) and a fourth image D indicating twelve forty-seven (12:47), and provide the second display data DDATA2 to the display driver circuit 100a. In an exemplary embodiment, the second processor 400 may transmit a trigger signal TR indicating that the transmitted data is display data, along with the second display data DDATA2.

Meanwhile, the first MUX 120 may sequentially select the first display data DDATA1 corresponding to the second image B and the second display data DDATA2 corresponding to the third image C and the fourth image D and provide the first display data DDATA1 and the second display data DDATA2 as input display data to the memory module 150a. The memory controller 151 of the memory module 150a may write the first display data DDATA1 corresponding to the second image B in the first memory region 152a, and write the second display data DDATA2 corresponding to the third image C in the second memory region 152b. The second MUX 153 may select and output one of pieces of display data output by the first memory region 152a and the second memory region 152b in response to an output selection signal OSS.

As described above, the second controller 160 may generate the output selection signal OSS based on an operating mode or a predetermined time period. For instance, the second controller 160 may change the output selection signal OSS at intervals of one minute. Thus, the first display data DDATA1 corresponding to the second image B may be output to the timing controller 140 for one minute of the second time period T2 so that the second image B may be displayed on the display panel 200. For one minute of a third time period T3, the second display data DDATA2 corresponding to the third image C may be output to the timing controller 140 to display the third image C on the display panel 200.

During the third time period T3 for which the third image C is displayed, the second processor 400 may generate the second display data DDATA2 corresponding to the fourth image D indicating twelve forty-seven (12:47), and provide the second display data DDATA2 to the display driver circuit 100a. The memory controller 151 may write the second display data DDATA2 corresponding to the fourth image D in the first memory region 152a. For one minute of a fourth time period T4, the second controller 160 may output second display data DDATA2 corresponding to the fourth image D to the timing controller 140, so that the fourth image D (i.e., twelve forty-seven) may be displayed on the display panel 200.

After the fourth time period T4, the display system 1000 may be switched to the first operating mode, for example, the normal operating mode, again. Thus, the first processor 300 may generate first display data DDATA1 corresponding to a fifth image E and provide the first display data DDATA1 to the display driver circuit 100a, and the display driver circuit 100a may display an image on the display panel 200 based on the first display data DDATA1.

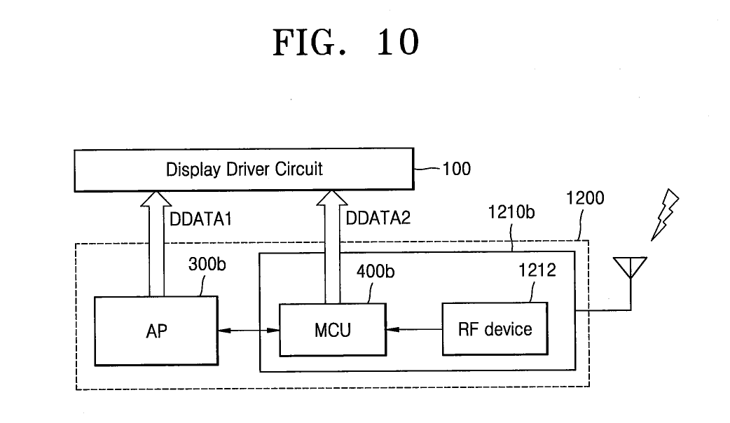

FIG. 10 is a block diagram of a system control unit 1200 according to an exemplary embodiment of the inventive concept.

Referring to FIG. 10, the system control unit 1200 may include a first processor 300b and a first operating module 1210b that may include a second processor 400b. In the present embodiment, the first operating module 1210b may include a communication module. The second processor 400b may be a communication processor.

The first operating module 1210b may include the second processor 400b and an RF device 1212. The RF device 1212 may externally receive data and provide the received data to the second processor 400b. The second processor 400b may provide the received data or information regarding the received data to the first processor 300b.

When the display system (refer to 1000 in FIG. 1) including the system control unit 1200 operates in a second operating mode, the second processor 400b may generate second display data DDATA2 based on the received data or information regarding the received data, and provide the generated second display data DDATA2 to the display driver circuit 100.

In an exemplary embodiment, when the received data is simple data regarding, for example, text data or data regarding the receiving of a phone call, the second processor 400b may generate second display data DDATA2 and provide the generated second display data DDATA2 to the display driver circuit 100. When the received data is complicated data, such as moving image data, the second processor 400b may transmit the data or information regarding the data to the first processor 300b. When the first processor 300b is in a dormant status, the second processor 400b may make a wake-up request of the first processor 300b.

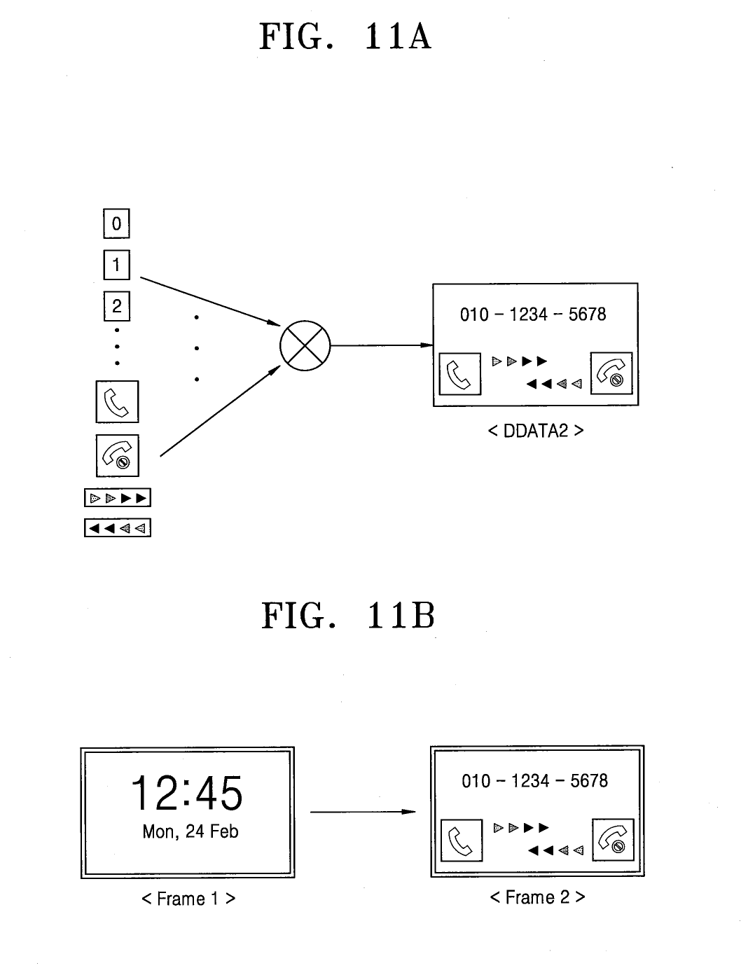

FIG. 11A is a diagram of second display data generated by the second processor 400b shown in FIG. 10, and FIG. 11B is a diagram showing a variation in an image displayed on a display panel. In FIGS. 11A and 11B, it is assumed that the display system 1000 is mounted on a smartphone.

Referring to FIG. 11A, when the smartphone received the call, the RF device 1212 may externally receive a call request or data including information regarding a calling device that makes a call request. The second processor 400b may generate second display data DDATA2 based on the received data. In an exemplary embodiment, the second processor 400b may generate second display data DDATA2 corresponding to an image of at least one frame to be displayed on the display panel 200 by using a composite of a plurality of symbol image data corresponding to the components of received data.

Referring to FIG. 11B, a call answering image Frame2 corresponding to the second display data DDATA2 provided by the second processor 400b may be displayed on the display panel 200 on which a time image Frame1 has been displayed.

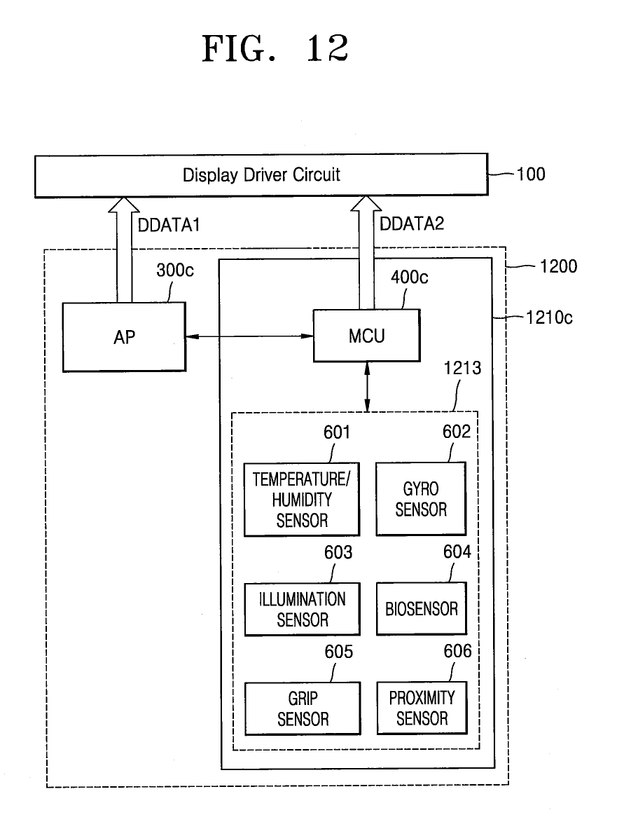

FIG. 12 is a block diagram of a system control unit 1200 according to an exemplary embodiment of the inventive concept.

Referring to FIG. 12, the system control unit 1200 may include a first processor 300c and a first operating module 1210c that may include a second processor 400c. In the present embodiment, the first operating module 1210c may be a sensing module. For example, the first operating module 1210c may be a sensor hub, and the second processor 400c may be an MCU configured to control operations of the sensor hub.

The first operating module 1210c may include the second processor 400c and a sensing unit 1213. The sensing unit 1213 may include various sensors, for example, a temperature/humidity sensor 601, a gyro sensor 602, an illumination sensor 603, a biosensor 604, a grip sensor 605, and a proximity sensor 606.

The second processor 400c may provide sensing signals received from the sensors 601 to 606 or information regarding the sensing signals, to the first processor 300c. When the display system 1000 including the system control unit 1200 operates in a second operating mode, the second processor 400c may generate second display data DDATA2 based on the sensing signals or the information regarding the sensing signals, and provide the second display data DDATA2 to the display driver circuit 100.

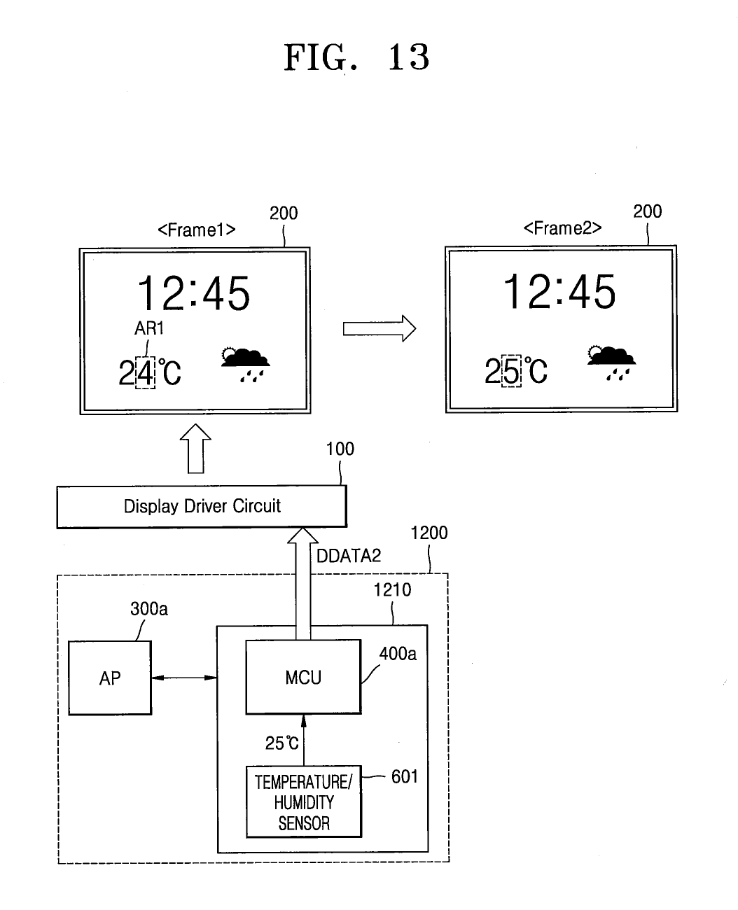

FIG. 13 is a diagram showing a variation in an image displayed on a display panel according to an operation of the second processor 400c shown in FIG. 12.

Referring to FIG. 13, the temperature/humidity sensor 601 may sense a current temperature and provide a sensing signal to the second processor 400c. Since the current temperature sensed by the temperature/humidity sensor 601 is about 25° C. and a temperature currently displayed on the display panel 200 is about 24° C., the second processor 400c may update an image displayed on the display panel 200. In an exemplary embodiment, the second processor 400c may generate second display data DDATA2 for updating part of the image displayed on the display panel 200, for example, only a first region AR1 indicating a temperature. For example, the second display data. DDATA2 may be data corresponding to an image of a number 5. In an exemplary embodiment, as described with reference to FIG. 12, the second processor 400c may generate second display data DDATA2 corresponding to an image of at least one frame to be displayed on the display panel 200.

The display driver circuit 100 may drive the display panel 200, based on the second display data DDATA2 received from the second processor 400c. Thus, an image Frame1 indicating a temperature of about 24° C. may be updated to an image Frame2 indicating a temperature of about 25° C.

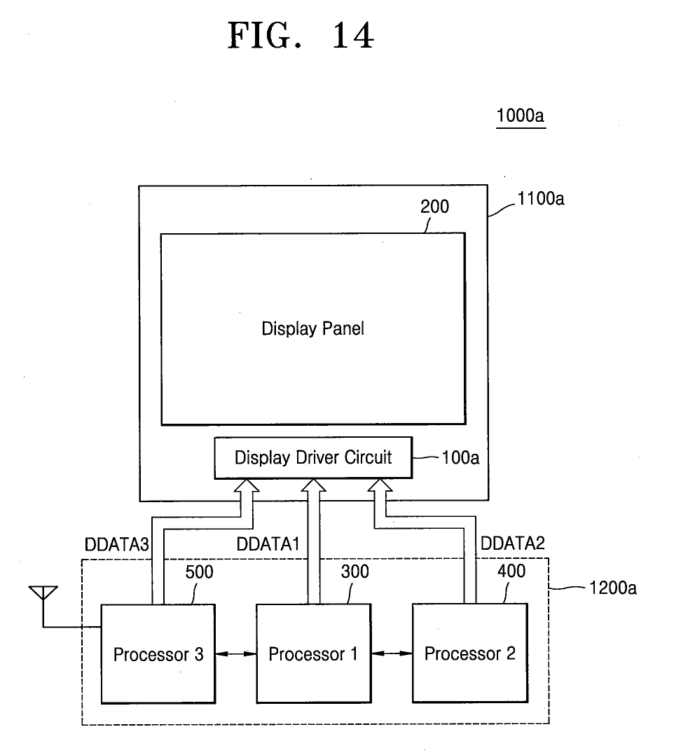

FIG. 14 is a block diagram of a display system 1000a according to an exemplary embodiment of the inventive concept.

Referring to FIG. 14, the display system 1000a may include a display device 1100a and a system control unit 1200a. The display device 1100a may include a display panel 200 and a display driver circuit 100a.

The system control unit 1200a may include a first processor 300, a second processor 400, and a third processor 500. The first processor 300 may generate first display data DDATA1 and provide the first display data DDATA1 to the display driver circuit 100a. The second processor 400 may generate second display data DDATA2 and provide the second display data DDATA2 to the display driver circuit 100a. The third processor 500 may generate third display data DDATA3 and provide the third display data DDATA3 to the display driver circuit 100a. The display driver circuit 100a may drive the display panel 200 based on one of the first display data DDATA1, the second display data DDATA2, and the third display data DDATA3 received from the first, second, and third processors 300, 400, and 500.

In an exemplary embodiment, the first processor 300 may transmit the first display data DDATA1 through a first interface, and the second processor 400 may transmit the second display data DDATA2 through a second interface. The third processor 500 may transmit the third display data DDATA3 through a third interface. As an example, the first to third interfaces may be of the same kind or of different kinds. As another example, the second interface and the third interface may be of the same kind, and the first interface may be a different interface from the second and third interfaces. In this case, a transmission rate of the first interface may be higher than transmission rates of the second and third interfaces.

In an exemplary embodiment, the first processor 300 may be a main processor configured to control all operations of an electronic device on which the display system 1000a is mounted. For example, the first processor 300 may be an application processor (AP).

In an exemplary embodiment, the second processor 400 and the third processor 500 may be processors that are included in operating modules of the electronic device and control operations of the operating modules. For example, the second processor 400 or the third processor 500 may be a communication processor or an MCU included in a sensor hub.

In an exemplary embodiment, when the display system 1000a is in a first operating mode, for example, in a normal operating mode, the first processor 300 may generate first display data DDATA1 and transmit the first display data DDATA1 to the display driver circuit 100a, and the display driver circuit 100a may drive the display panel 200 based on the first display data DDATA1. When the display system 1000a is in a second operating mode, for example, a low-power operating mode, the first processor 300 may be maintained in a dormant status, and the second processor 400 or the third processor 500 may perform an image update operation. The display driver circuit 100a may drive the display panel 200 based on the second display data DDATA2 received from the second processor 400 or the third display data DDATA3 received from the third processor 500.

In another exemplary embodiment, the display system 1000a may operate in at least three operating modes, and the first processor 300, the second processor 400, and the third processor 500 may perform image update operations in respectively different operating modes.

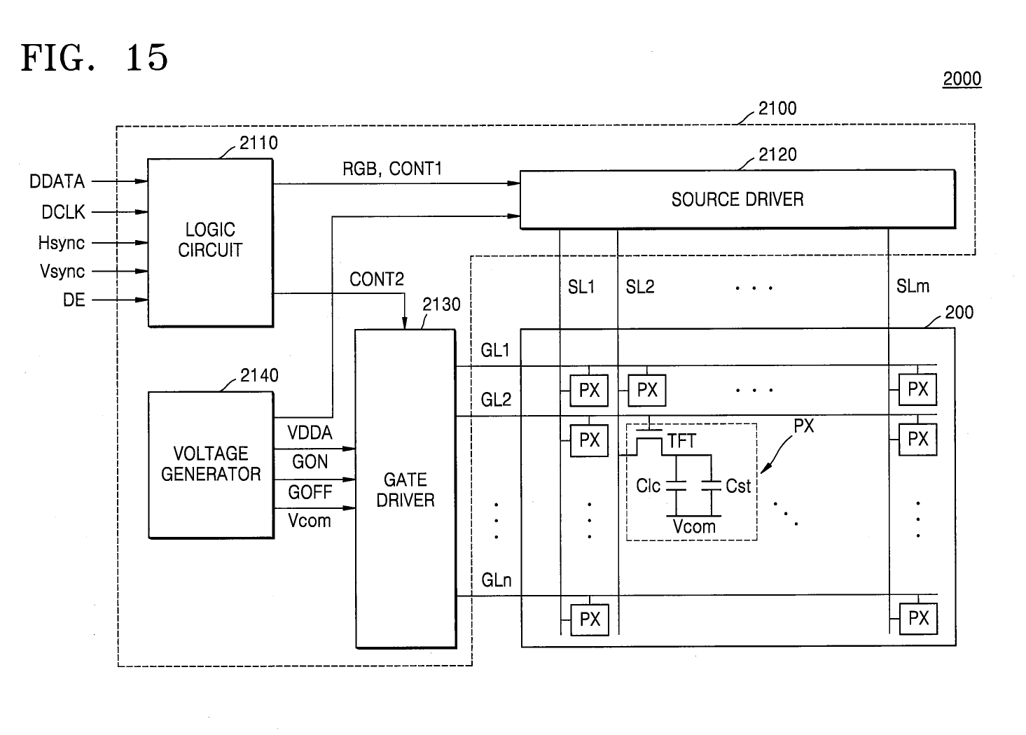

FIG. 15 is a block diagram of a display device 2000 according to an exemplary embodiment of the inventive concept.

Referring to FIG. 15, the display device 2000 may include a display panel 200 and a display driver circuit 2100.

The display panel 200 may display an image in frame units. The display panel 200 may be embodied by an LCD, an LED display, an OLED display, an AMOLED display, or a flexible display, or embodied by one of other kinds of FPDs. For brevity, the present embodiment will describe an example in which the display panel 200 is an LCD panel.

The display panel 200 may include gate lines GL1 to GLn arranged in a row direction, source lines SL1 to SLm arranged in a column direction, and pixels PX formed at intersections between the gate lines GL1 to GLn and the source lines SL1 to SLm. In the display panel 200, as shown in FIG. 15, each of the pixels PX may include a thin-film transistor (TFT) and an LC capacitor Clc and a storage capacitor Cst connected to a drain of the TFT. A common voltage Vcom may be applied to the other terminals of the LC capacitor Clc and the storage capacitor Cst. When the gate lines GL1 to GLn are sequentially scanned, a TFT of the pixel PX connected to the selected gate line may be turned on, and a gradation voltage corresponding to display data RGB may be applied to each of the source lines SL1 to SLm. The gradation voltage may be applied through the TFT of the corresponding pixel PX to the LC capacitor Clc and the storage capacitor Cst, and the LC capacitor Clc and the storage capacitor Cst may be driven to enable a display operation.

The display driver circuit 2100 may include a source driver 2120, a gate driver 2130, a logic circuit 2110, and a voltage generator unit 2140. The display driver circuit 2100 may be embodied by one semiconductor chip or a plurality of semiconductor chips.

The logic circuit 2110 may receive display data DDATA, a horizontal synchronous signal Hsync, a vertical synchronous signal Vsync, a clock signal DCLK, and a data enable signal DE from an external device (e.g., a host device), and generate control signals CONT1 and CONT2 for controlling the gate driver 2130 and the source driver 2120 in response to the received signals. Also, the logic circuit 2110 may convert a format of externally received display data DDATA to meet specifications for an interface with the source driver 2120, generate display data RGB, and transmit the display data RGB to the source driver 2120. A configuration and operations of the logic circuit 2110 may be substantially the same as those of the display driver circuits 100 and 100a. The logic circuit 2110 may include an interface unit, a selector, and a timing controller. Also, the logic circuit 2110 may include a memory configured to store the received display data DDATA.

The gate driver 2130 and the source driver 2120 may drive pixels PX of the display panel 200 in response to the control signals CONT1 and CONT2 provided by the logic circuit 2110.

The source driver 2120 may drive the source lines SL1 to SLm of the display panel 200 in response to a source driver control signal CONT1. The gate driver 2130 may sequentially drive the scan gate lines GL1 to GLn of the display panel 200. The gate driver 2130 may apply a gate-on voltage GON to a selected gate line and activate the selected gate line. The source driver 2120 may output a gradation voltage corresponding to pixels connected to the activated gate line. Thus, the display panel 200 may display an image in units of horizontal lines, that is, in row units.

The voltage generator unit 2140 may generate voltages to be used by the display driver circuit 2100 and the display panel 200. The voltage generator unit 2140 may generate a gate-on voltage GON, a gate-off voltage GOFF, a common voltage Vcom, and an analog power supply voltage VDDA. The gate-on voltage GON and the gate-off voltage GOFF may be provided to the gate driver 2130 and used to generate a gate signal to be applied to the gate lines G1 to Gn. The common voltage Vcom may be equally provided to the pixels PX of the display panel 200. As shown in FIG. 15, the common voltage Vcom may be provided to one terminal of an LC capacitor Clc and one terminal of a storage capacitor Cst. The analog power supply voltage VDDA may be used during an operation of the source driver 2120.

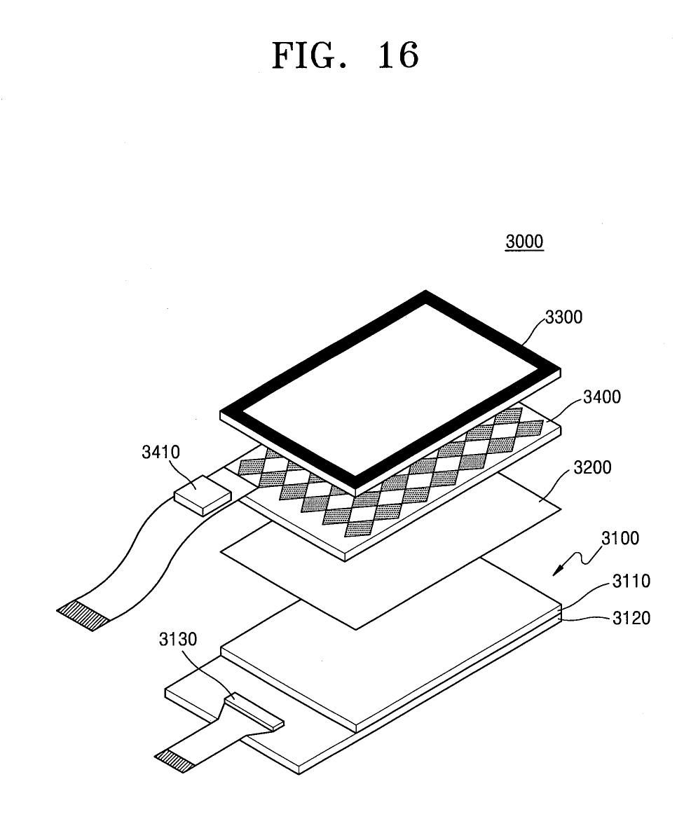

FIG. 16 is a diagram of a display module 3000 according to an exemplary embodiment of the inventive concept.

Referring to FIG. 16, the display module 3000 may include a display device 3100, a polarizer 3200, and a window glass 3300. The display device 3100 may include a display panel 3110, a printed circuit board (PCB) 3120, and a display driver IC 3130.

The window glass 3300 may be formed of acryl or reinforced glass and protect the display module 3000 from external impact or scratches caused by repeated touches. The polarizer 3200 may be provided to improve optical properties of the display device 3100. The display panel 3110 may be formed by patterning a transparent electrode on the PCB 3120. The display panel 3110 may include a plurality of pixels to display a frame image. According to an exemplary embodiment, the display panel 3110 may be an LCD panel. However, the inventive concept is not limited thereto, and the display panel 3110 may include various kinds of display devices. For example, the display panel 3110 may be one of an OLED panel, an ECD panel, a DMD panel, an AMD panel, a GLV panel, a PDP panel, an ELD panel, an LED display panel, and a VFD panel.

The display driver IC 3130 may include the display driver circuits 100 and 100a according to the exemplary embodiments of the inventive concept. Although the present embodiment illustrates a case in which the display driver IC 3130 includes a single chip for brevity, the display driver IC 3130 may include a plurality of chips. Also, the display driver IC 3130 may be mounted as a chip-on-glass (COG) type on a PCB formed of glass. However, the inventive concept is not limited to the present embodiment, and the display driver IC 3130 may be mounted in various manners, for example, a chip-on-film (COF) type or a chip-on-board (COB) type.

The display module 3000 may further include a touch panel 3400 and a touch controller 3410. The touch panel 3400 may be formed by patterning a transparent electrode formed of, for example, indium tin oxide (ITO), on a glass substrate or a polyethylene terephthalate (PET) film. The touch controller 3410 may detect generation of a touch on the touch panel 3400, calculate touch coordinates, and transmit the touch coordinates to a host. The touch controller 3410 may be integrated with the display driver IC 3130 in one semiconductor chip.

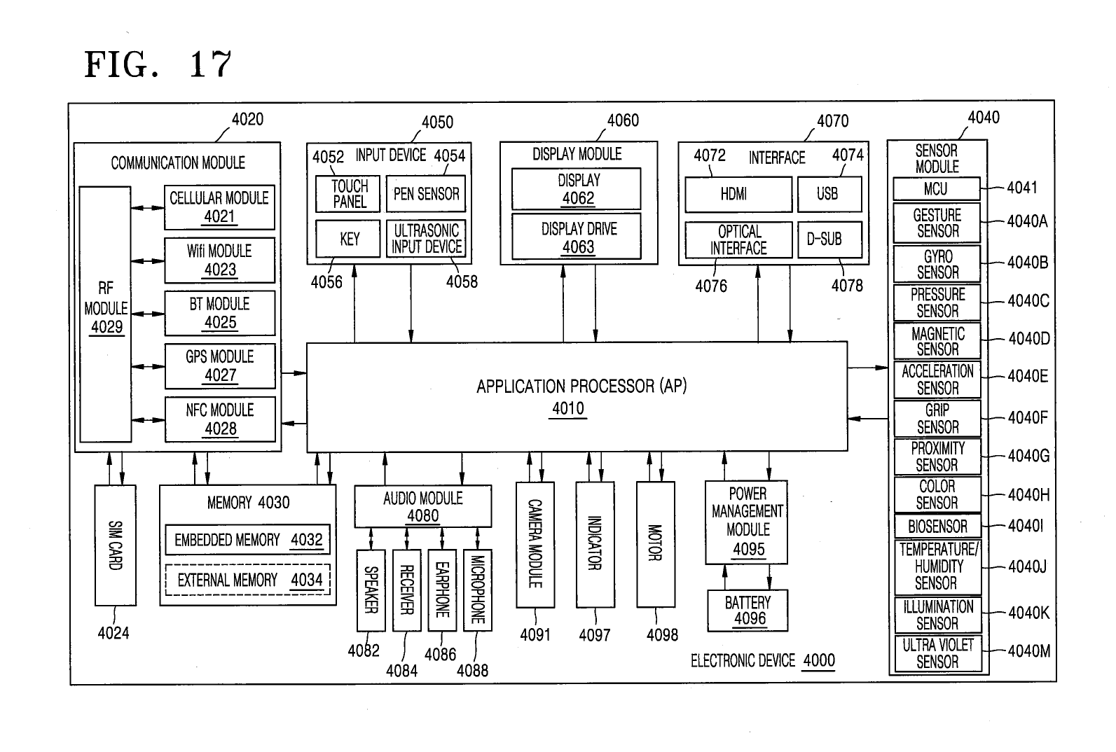

FIG. 17 is a block diagram of an electronic device 4000 according to an exemplary embodiment of the inventive concept.

The electronic device 4000 may include, for example, all or part of the display system 1000 shown in FIG. 1 or all or part of the display system 1000a shown in FIG. 14. Referring to FIG. 17, the electronic device 4000 may include at least one AP 4010, a communication module 4020, a subscriber identification module (SIM) card 4024, a memory 4030, a sensor module 4040, an input device 4050, a display module 4060, an interface 4070, an audio module 4080, a camera module 4091, a power management module 4095, a battery 4096, an indicator 4097, and a motor 4098.

The AP 4010 may drive an operating system (OS) or an applied program and control a plurality of hardware or software components connected to the AP 4010, and process and calculate various pieces of data including multimedia data. The AP 4010 may be embodied by, for example, an SoC. According to an exemplary embodiment, the AP 4010 may further include a graphics processing unit (GPU).

The communication module 4020 may transmit or receive data during communication between the electronic device 4000 and other electronic devices that are connected via a network. According to an exemplary embodiment, the communication module 4020 may include a cellular module 4021, a WiFi module 4023, a Bluetooth (BT) module 4025, a GPS module 4027, a near-field communication (NFC) module 4028, and a radio-frequency (RF) module 4029.

The cellular module 4021 may provide voice calls, video calls, a message service, or an Internet service through a communication network (e.g., LTE, LTE-A, CDMA, WCDMA, UMTS, WiBro, or GSM). Also, the cellular module 4021 may discriminate electronic devices and authenticate an electronic device in a communication network using, for example, a subscriber identification module (e.g., the SIM card 4024). According to an exemplary embodiment, the cellular module 4021 may serve at least part of functions that may be provided by the AP 4010. For instance, the cellular module 4021 may provide at least part of a multimedia control function.

According to an exemplary embodiment, the cellular module 4021 may include a communication processor (CP). Also, the cellular module 4021 may be embodied by, for example, an SoC. FIG. 17 illustrates a case in which components, such as the cellular module 4021 (e.g., a CP), the memory 4030, and the power management module 4095, are distinct from the AP 4010, but the inventive concept is not limited thereto. According to an exemplary embodiment, the AP 4010 may include at least some (e.g., the cellular module 4021) of the above-described components.

According to an exemplary embodiment, the AP 4010 or the cellular module 4021 (e.g., a CP) may load a command or data, which is received from at least one of a non-volatile memory or other components that are connected to each of the AP 4010 or the cellular module 4021, in a volatile memory and process the command or data. Also, the AP 4010 or the cellular module 4021 may store data, which is received from or generated by at least one of the other components, in the non-volatile memory.

Each of the WiFi module 4023, the BT module 4025, the GPS module 4027, or the NFC module 4028 may include, for example, a processor configured to process data transmitted or received through the corresponding module. FIG. 17 illustrates a case in which the cellular module 4021, the WiFi module 4023, the BT module 4025, the GPS module 4027, and the NFC module 4028 are distinct from one another, but the inventive concept is not limited thereto. According to an exemplary embodiment, at least some (e.g., at least two) of the cellular module 4021, the WiFi module 4023, the BT module 4025, the GPS module 4027, and NFC module 4028 may be included in one integrated chip (IC) or an IC package. For example, at least some (e.g., a CP corresponding to the cellular module 4021 and a WiFi processor corresponding to the WiFi module 4023) processors corresponding respectively to the cellular module 4021, the WiFi module 4023, the BT module 4025, the GPS module 4027, and the NFC module 4028 may be embodied by one SoC.

The RF module 4029 may transmit or receive data, for example, transmit or receive RF signals. The RF module 4029 may include, for example, a transceiver, a power amp module (PAM), a frequency filter, or a low noise amplifier (LNA). Also, the RF module 4029 may further include components (e.g., a conductor or a conducting wire) for transmitting or receiving electromagnetic waves (EMWs) on a free space in a wireless communication system. FIG. 17 illustrates a case in which one RF module 4029 is shared among the cellular module 4021, the WiFi module 4023, the BT module 4025, the GPS module 4027, and the NFC module 4028, but the inventive concept is not limited thereto. According to an exemplary embodiment, at least one of the cellular module 4021, the WiFi module 4023, the BT module 4025, the GPS module 4027, and the NFC module 4028 may transmit or receive RF signals through a distinct RF module.

The SIM card 4024 may be a card including a subscriber identification module. The SIM card 4024 may be inserted into a slot formed in a specific location of the electronic device 4000. The SIM card 4024 may include intrinsic identification information (e.g., an integrated circuit card identifier (ICCID) or subscriber information (e.g., international mobile subscriber identity (IMSI)).

The memory 4030 may include an embedded memory 4032 or an external memory 4034. The embedded memory 4032 may include, for example, at least one of a volatile memory, such as dynamic RAM (DRAM), static RAM (SRAM), synchronous dynamic RAM (SDRAM), or a non-volatile memory, such as one-time programmable ROM (OTPROM), programmable ROM (PROM), erasable and programmable ROM (EPROM), electrically erasable and programmable ROM (EEPROM), mask ROM, flash ROM, a NAND flash memory, or a NOR flash memory.

According to an exemplary embodiment, the embedded memory 4032 may include a solid-state drive (SSD). The external memory 4034 may further include a flash drive, for example, a compact flash (CF), a secure digital (SD), a micro-SD, a mini-SD, an extreme digital (xD) or a memory stick. The external memory 4034 may be functionally connected to the electronic device 4000 through various interfaces. According to an exemplary embodiment, the electronic device 4000 may further include a storage device (or a storage medium), such as a hard drive.

The sensor module 4040 may measure a physical quantity or sense an operating status of the electronic device 4000 and convert measured or sensed information into an electric signal. The sensor module 4040 may include, for example, at least one of a gesture sensor 4040A, a gyro sensor 4040B, a pressure sensor 4040C, a magnetic sensor 4040D, an acceleration sensor 4040E, a grip sensor 4040F, a proximity sensor 4040G, a color sensor 4040H (e.g., a red/green/blue (RGB) sensor), a biosensor 4040I, a temperature/humidity sensor 4040J, an illumination sensor 4040K, or an ultraviolet (UV) sensor 4040M. Additionally or alternatively, the sensor module 4040 may include, for example, an E-nose sensor, an electromyography (EMG) sensor, an electroencephalogram (EEG) sensor, an electrocardiogram (ECG) sensor, an infrared (IR) sensor, an iris sensor, or a fingerprint sensor. The sensor module 4040 may further include an MCU 4041 configured to control at least one sensor included therein.

The input device 4050 may include a touch panel 4052, a (digital) pen sensor 4054, a key 4056, or an ultrasonic input device 4058. The touch panel 4052 may recognize a touch input in, for example, at least one of a capacitive manner, a resistive manner, an IR manner, or an ultrasonic manner. Also, the touch panel 4052 may further include a control circuit. When the touch panel 4052 is of a capacitive type, the touch panel 4052 may enable a physical contact or proximate contact. The touch panel 4052 may further include a tactile layer. In this case, the touch panel 4052 may provide a tactile reaction to a user.

The (digital) pen sensor 4054 may be embodied in the same manner as or a similar manner to a method of receiving a user's touch input or by using an additional recognition sheet. The key 4056 may include, for example, a physical button or an optical key or keypad. The ultrasonic input device 4058 may sense sound waves by using a microphone 4088 of the electronic device 4000 through an input tool capable of generating ultrasonic signals, and confirm data. The ultrasonic input device 4058 may enable wireless recognition. According to an exemplary embodiment, the electronic device 4000 may receive a user's input from an external device (e.g., a computer or server) connected thereto, by using the communication module 4020.

The display module 4060 may include a display panel 4062 and a display driver 4063. The display panel 4062 may include, for example, an LCD or an AMOLED panel. For example, the display panel 4062 may be made flexible, transparent, or wearable. The display panel 4062 and the touch panel 4052 may be a single module. The display panel 4062 may include a plurality of regions. Alternatively, a plurality of display panels 4062 may be provided.

The display panel 4062 may be replaced by a hologram device or a projector. The hologram device may display a stereoscopic image in the air using light interference. The projector may project light to a screen and display an image on the screen. For example, the screen may be located inside or outside the electronic device 4000.

The display driver 4063 may include a plurality of driver modules and drive the display panel 4062. Each of the plurality of driver modules may receive an image corresponding to the AP 4010, and display the received image on the corresponding region of the display panel 4062 or on the corresponding one of a plurality of display panels 4062. In this case, the plurality of driver modules may share processing information regarding the received image therebetween, and compensate for the image based on the processing information.

The interface 4070 may include, for example, a high-definition multimedia interface (HDMI) 4072, a universal serial bus (USB) 4074, an optical interface 4076, or a D-subminiature (D-sub) 4078. Additionally or alternatively, the interface 4070 may include, for example, a mobile high-definition link (MHL) interface, a secure digital (SD) card/multi-media card (MMC) interface, or an infrared data association (IrDA)-standard interface.

The audio module 4080 may convert sound and electric signals into each other. The audio module 4080 may process sound information input or output through, for example, a speaker 4082, a receiver 4084, an earphone 4086, or the microphone 4088.

The camera module 4091 may be a device capable of capturing still images or moving images. According to an exemplary embodiment, the camera module 4091 may include at least one image sensor (e.g., a front-illuminated sensor or a back-illuminated sensor), a lens, an image signal processor (ISP), or a flash (e.g., an LED or a xenon lamp).

The power management module 4095 may manage power of the electronic device 4000. Although not shown, the power management module 4095 may include, for example, a power management integrated circuit (PMIC), a charger IC, or a battery or fuel gauge.

The PMIC may be mounted in, for example, an IC or a SoC semiconductor. A charging type may be classified into a wired type and a wireless type. The charger IC may charge a battery and prevent an overvoltage or overcurrent from flowing from a battery charger. According to an exemplary embodiment, the charger IC may include at least one of a charger IC of a wired charging type or a charger IC of a wireless charging type. The wireless charging type may be, for example, a magnetic resonance type, a magnetic induction type, or an EMW type, and further include an additional circuit (e.g., a coil loop, a resonance circuit, or a rectifier) for the wireless charging type.

The battery gauge may measure, for example, a battery level of the battery 4096, a charging voltage, a charging current, or a charging temperature. The battery 4096 may store or generate electricity, and supply power to the electronic device 4000 using the stored or generated electricity. The battery 4096 may include, for example, a rechargeable battery or a solar battery.

The indicator 4097 may indicate a specific status of the electronic device 4000 or a part (e.g., the AP 4010) thereof, for example, a booting status, a message status, or a charging status. The motor 4098 may convert an electric signal into mechanical oscillation. The electronic device 4000 may include a processing device (e.g., a GPU) for supporting a mobile TV. The processing device for supporting the mobile TV may process media data based on standards, such as digital multimedia broadcasting (DMB), digital video broadcasting (DVB), or media flow.

In the electronic device 4000 according to an exemplary embodiment of the inventive concept, sub-processors (e.g., a CP included in the cellular module 4021 and the MCU 4041 included in the sensor module 4040) included in the AP 4010 and the respective modules may generate display data. In an exemplary embodiment, the AP 4010 may generate display data and provide the display data to the display driver 4063 during a normal operation, and generate display data during a low-power operation. Thus, since the AP 4010 may be maintained in a dormant status, power consumption of the electronic device 4000 may be reduced.

Each of the above-described elements of an electronic device according to various exemplary embodiments of the inventive concept may include at least one component, and the corresponding element may be called a different name according to the type of the electronic device. The electronic device according to the various exemplary embodiments of the inventive concept may include at least one of the above-described elements. Some elements may be omitted from the electronic device or other elements may be added to the electronic device. Also, some of the elements of the electronic device according to the various exemplary embodiments of the inventive concept may be combined into one entity and provide the same functions as the corresponding elements.

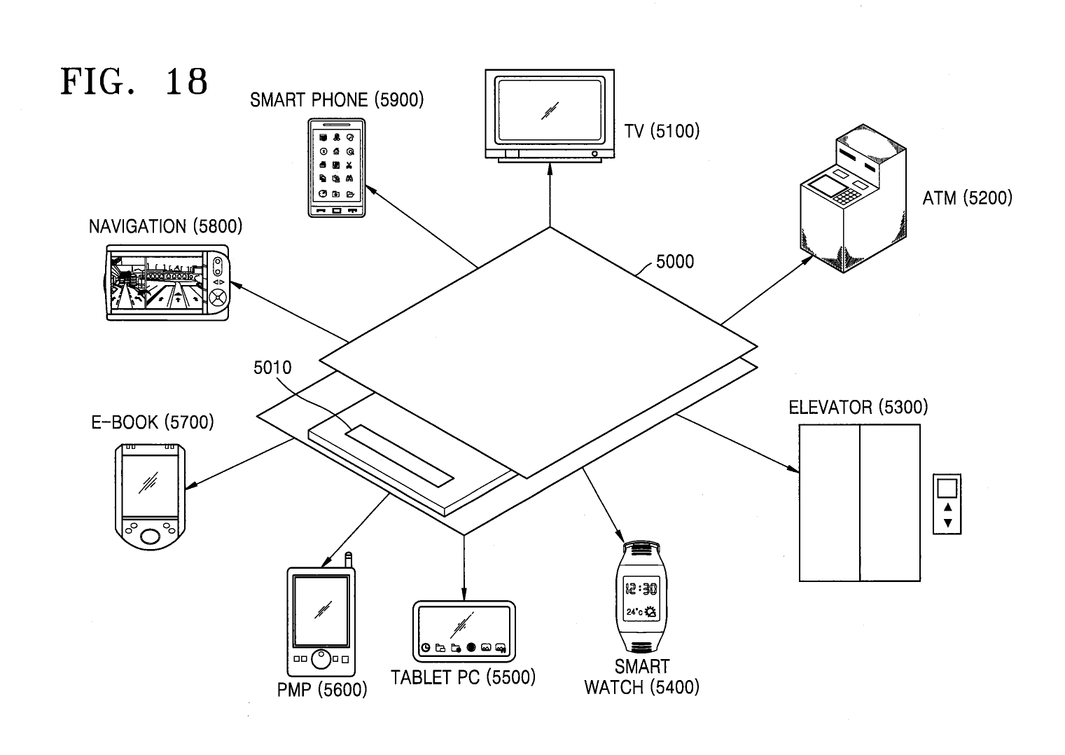

FIG. 18 is a diagram of various applied examples of an electronic product on which a display device 5000 according to an exemplary embodiment of the inventive concept is mounted. The display device 5000 according to the inventive concept may be applied to various electronic products. The display device 5000 according to the inventive concept may be not only applied to a smartphone 5900, but also widely used in a TV 5100, an ATM 5200 configured to automatically execute the receipt and payment of cash for banks, an elevator 5300, a smartwatch 5400 used on the subway, a tablet PC 5500, a PMP 5600, an e-book 5700, and a navigation device 5800.

While the inventive concept has been particularly shown and described with reference to exemplary embodiments thereof, it will be understood that various changes in form and details may be made therein without departing from the spirit and scope of the following claims.

What is claimed is:

1. A display system comprising:
a first processor circuit configured to generate first data and output the first data;
a second processor circuit configured to generate second data and output the second data; and
a display driver circuit configured to generate a driver signal based on one of the first data received from the first processor circuit and the second data received from the second processor circuit.

2. The display system of claim 1, further comprising:
a display panel coupled to the display driver circuit, wherein the first data and the second data comprise display data corresponding to an image displayed on the display panel.

3. The display system of claim 1, wherein the first processor circuit transmits the first data to the display driver circuit through a first interface,
the second processor circuit transmits the second data to the display driver circuit through a second interface, and
a transmission rate of the first interface is higher than a transmission rate of the second interface.

4. The display system of claim 1, wherein the first processor circuit comprises an application processor circuit configured to control an operation of an electronic device on which the display system is mounted, and
the second processor circuit comprises a micro-control unit (MCU) configured to control a communication module or a sensor module included in the electronic device.

5. The display system of claim 1, wherein the second processor circuit generates the second data based on an external sensing signal when the first processor circuit is in a dormant state.

6. The display system of claim 1, wherein the first processor circuit transmits a command signal indicating a lower-power operating mode to the second processor circuit and enters a dormant state, and the second processor circuit generates the second data in response to the command signal.

7. The display system of claim 6, wherein the second processor circuit generates the second data in response to a sensing signal when an external sensing signal is of a first type, and transmits the sensing signal and a normal operation request signal when the sensing signal is of a second type.

8. The display system of claim 1, wherein the second processor circuit transmits a trigger signal indicating transmission of the second data along with the second data to the display driver circuit.

9. The display system of claim 1, further comprising a third processor circuit configured to generate third data and output the third data,
wherein the display driver circuit generates a driver signal based on the first data received from the first processor circuit, the second data received from the second processor circuit, or the third data received from the third processor circuit.

10. A mobile electronic device comprising the display system of claim 1.

11. A display driver circuit comprising:
an input selector configured to select one of first data received through a first interface and second data received through a second interface, as input data, in response to a data selection signal;
an input control unit configured to generate the data selection signal according to an operating mode; and
a timing controller configured to perform a processing operation to display an image including the input data on a display panel.

12. The display driver circuit of claim 11, wherein the first data and the second data are received from a first high-power processor circuit and a second low-power processor circuit, respectively.

13. The display driver circuit of claim 11, further comprising a storage unit configured to store the input data,
wherein the storage unit comprises a plurality of storage regions configured to sequentially store a plurality of pieces of input data that are output by the input selector in a temporal sequence.

14. The display driver circuit of claim 13, further comprising:
an output selector configured to select one of the plurality of pieces of data output by the plurality of storage regions, as output data, in response to an output selection signal; and
an output control unit configured to generate the output selection signal based on the operating mode or a time period.

15. The display driver circuit of claim 14, wherein the output control unit comprises a clock counter configured to count applied clocks, determine the time period, and generate the output selection signal for sequentially selecting data for each time period.

16. A display driver circuit comprising:
an input selector circuit configured to receive first display data from a high power processor circuit configured to operate in a normal mode in which the first display data is provided and in a dormant mode in which no image data is provided to the input selector circuit and configured to receive second display data from a low power processor circuit that is configured provide the second display data when the high power processor circuit is in the dormant mode; and
a controller circuit, coupled to switch the first display data or the second display data through the input selector circuit based on the mode of operation of the high power processor circuit.

17. The circuit of claim 16 wherein the controller circuit is coupled to the first display data, wherein the controller circuit is configured to determine that the mode of operation of the high power processor circuit is normal based on a content of the first display.

18. The circuit of claim 16 further comprising:
a memory coupled to an output of the input selector circuit, wherein the controller circuit is configured to store the output of the input selector circuit in the memory when the high power processor circuit is in the dormant mode and is configured to bypass the memory when the high power processor circuit is in the normal mode.

19. The circuit of claim 16 further comprising;
a memory coupled to an output of the input selector circuit, wherein the memory further comprises:
a first memory region configured to store the first display data provided via the output of the input selector circuit; and
a second memory region configured to store the second display data provided via the output of the input selector circuit.

20. The circuit of claim 16 wherein the second display data comprises only a portion of a frame of image data that is updated within a static image display responsive to an indication by the low power processor circuit.
